(19) United States
(12) Patent Application Publication
(10) Pub. No.: US 2008/0260429 A1
(43) Pub. Date: Oct. 23, 2008

(54) Liquid transfer apparatus

(75) Inventors: Hiroyuki Sugiyama, Tokyo (JP); Katsuhiko Ono, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Komori Corporation

(21) Appl. No.: 11/985,403

(22) Filed: Nov. 14, 2007

(30) Foreign Application Priority Data
Nov. 29, 2006 (JP) 321945/2006

(51) Int. Cl. G03G 15/02

(52) U.S. Cl. 399/170

(57) ABSTRACT

A liquid transfer apparatus includes a first cylinder, second cylinder, target liquid transfer body, guide device, and corona discharge processing device. The first cylinder is supported rotatably. The second cylinder is arranged to oppose the first cylinder and supported rotatably. Liquid is transferred to the target liquid transfer body when the target liquid transfer body travels between the first cylinder and the second cylinder. The guide device is conductive at least partially and arranged more upstream of the target transfer body in its traveling direction than the first cylinder and the second cylinder, and guides the target liquid transfer body. The corona discharge processing device is arranged to oppose the guide device and performs corona discharge for the target liquid transfer body traveling by being guided by the guide device.

### BACKGROUND OF THE INVENTION

The present invention relates to a liquid transfer apparatus in a printing press or coating device, which modifies the surface of a printing film or sheet before transferring ink or varnish to the printing film or paper sheet.

In general, a printing film, paper sheet, or the like undergoes a corona discharge process in advance to modify its surface. This is because corona discharge increases the adhesion properties of the ink, thus improving the printing result. It also improves the wear resistance of the surface of the printing film or paper sheet and decreases the amount of static electricity on the printing film, facilitating destaticization after the process.

If a comparatively long period of time elapses since a corona discharge process until printing, the effect of the corona discharge process lowers. This makes inventory management very difficult for printing films, paper sheets, or the like that have undergone the corona discharge process. Consequently, the printing films, paper sheets, or the like must be purchased in accordance with the printing schedule.

### SUMMARY OF THE INVENTION

It is an object of the present invention to provide a liquid transfer apparatus which can recover the effect of a corona discharge process.

In order to achieve the above object, according to the present invention, there is provided a liquid transfer apparatus comprising a first cylinder supported rotatably, a second cylinder arranged to oppose the first cylinder and supported rotatably, a target liquid transfer body to which a liquid is transferred when the target liquid transfer body travels between the first cylinder and the second cylinder, a guide device which is conductive at least partially and arranged more upstream of the target transfer body in a traveling direction thereof than the first cylinder and the second cylinder and which guides the target liquid transfer body, and a corona discharge processing device which is arranged to oppose the guide device and performing corona discharge for the target liquid transfer body traveling while being guided by the guide device.

### BRIEF DESCRIPTION OF THE DRAWINGS

FIG. 1 is a side view of a sheet-fed rotary printing press serving as a liquid transfer apparatus according to the first embodiment of the present invention;

FIG. 2 is a plan view of a ground cylinder shown in FIG. 1;

FIG. 3 is a block diagram showing the electrical arrangement of the liquid transfer apparatus shown in FIG. 1;

FIG. 4 is a side view of a sheet-fed rotary printing press according to the second embodiment of the present invention; and

FIG. 5 is a side view of a sheet-fed rotary printing press according to the third embodiment of the present invention.

### DESCRIPTION OF THE PREFERRED EMBODIMENTS

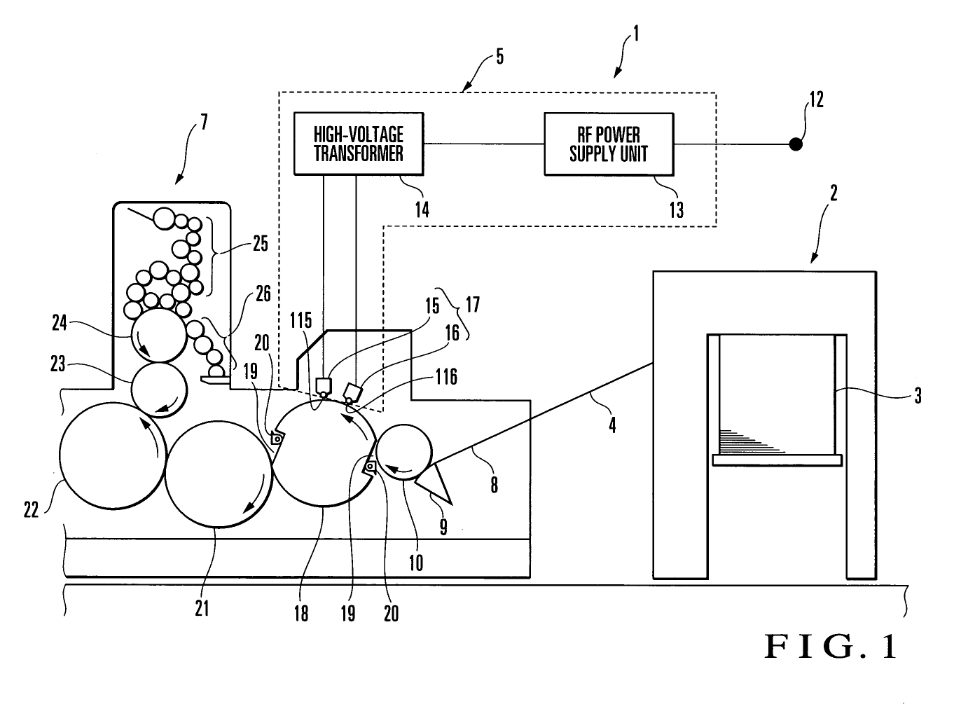

A liquid transfer apparatus according to the first embodiment of the present invention will be described with reference to FIGS. 1 to 3.

As shown in FIG. 1, a sheet-fed rotary printing press 1 comprises a feed device 2 which feeds out sheets 3, i.e., sheet type printing films serving as stacked target liquid transfer bodies, one by one onto a feeder board 4, a corona discharge processing device 5 having dischargers 115 and 116 which subject the surface of each sheet 3 to corona discharge, and a printing unit 7 which prints on the sheet 3 that has undergone a corona discharge process.

A feedboard 8 is provided to have a surface inclining downward from the feeder board 4 downstream in the sheet convey direction. A registration device (not shown) adjusts the widthwise direction (direction perpendicular to sheet traveling direction) and direction perpendicular to the widthwise direction (the sheet traveling direction) of the sheet 3 fed out from the feeder board 4 onto the feedboard 8. Then, a swing arm shaft pregripper 9 grips the leading edge of the sheet 3 and gripping-changes the sheet 3 to the grippers of a transfer cylinder 10.

The corona discharge processing device 5 comprises an RF power supply unit 13 which converts the power frequency of a commercial power supply 12 into RF, a high-voltage transformer 14 which boosts the power supply voltage converted into the RF, a dielectric electrode unit 17 to which RF high-voltage power from the high-voltage transformer 14 is supplied, and a stainless-steel conductive ground cylinder 18 (third cylinder) arranged upstream in the sheet convey direction of an impression cylinder 22 and blanket cylinder 23. The ground cylinder 18 serves as a guide portion which guides the sheet 3. The dielectric electrode unit 17 is arranged at a very small gap from the outer surface of the ground cylinder 18. The material of the ground cylinder 18 is not limited to stainless steel but may be any other material as far as it is a conductive metal.

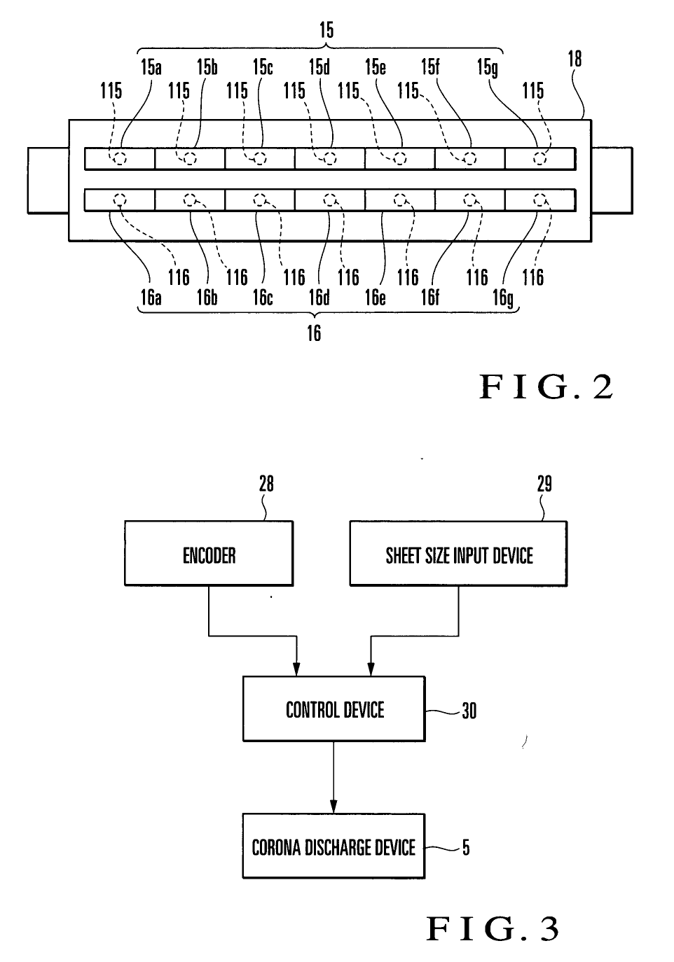

The dielectric electrode unit 17 comprises dielectric covered electrodes 15 and 16 arranged with different phases in the circumferential direction of the ground cylinder 18. As shown in FIG. 2, the dielectric covered electrodes 15 and 16 respectively comprise a plurality of dielectric covered electrode portions 15a to 15g and a plurality of dielectric covered electrode portions 16a to 16g which are arranged in two rows such that their adjacent ends are in contact with each other in the axial direction (direction perpendicular to the traveling direction of the sheet 3) of the ground cylinder 18. Each of the plurality of dielectric covered electrode portions 15a to 15g and each of the plurality of dielectric covered electrode portions 16a to 16g respectively have dischargers 115 and 116 at their centers.

The ground cylinder 18 is arranged to oppose the transfer cylinder 10. Notches 19 are formed in the peripheral portion of the ground cylinder 18, at positions phase-shifted from each other by 180° in the circumferential direction, to extend in the axial direction of the ground cylinder 18. Gripper devices (to be merely referred to as grippers hereinafter) 20 which grip the leading edge of the sheet 3 are mounted in the notches 19.

The printing unit 7 comprises a transfer cylinder 21 arranged to oppose the ground cylinder 18, the impression cylinder 22 (first cylinder) arranged to oppose the transfer cylinder 21, the blanket cylinder 23 (second cylinder) arranged to oppose the impression cylinder 22, a plate cylinder 24 which is in contact with the blanket cylinder 23, and an inking device 25 and dampening unit 26 which respectively supply ink and water to the outer surface of the plate cylinder 24.

Known grippers (not shown) which gripping-change the sheet 3, the leading edge of which is gripped by the grippers 20 of the ground cylinder 18, are arranged in the peripheral portion of the transfer cylinder 21 at positions phase-shifted from each other by 180° in the circumferential direction of the transfer cylinder 21. Known grippers (not shown) which gripping-change the sheet 3, the leading edge of which is gripped by the grippers of the transfer cylinder 21, are arranged in the peripheral portion of the impression cylinder 22 at positions phase-shifted from each other by 180° in the circumferential direction of the impression cylinder 22.

FIG. 3 is a block diagram showing the electrical arrangement of the liquid transfer apparatus according to this embodiment. As shown in FIG. 3, a control device 30 is connected to the corona discharge processing device 5, an encoder 28, and a sheet size input device 29. The encoder 28 is axially mounted on the end shaft of the transfer cylinder 10 and detects the position of the sheet 3 in the sheet traveling direction which is conveyed as it is gripped by the grippers of the ground cylinder 18. Upon key operation of the operator, the widthwise- and sheet traveling-direction sizes of the sheet 3 are input to the sheet size input device 29. The control device 30 controls the on/off operation of corona discharge processing device 5 on the basis of the sheet traveling-direction size of the sheet 3 output from the sheet size input device 29 and the sheet traveling-direction position of the sheet 3 which is output from the encoder 28.

This will be described in detail. When the leading edge of the sheet 3 which is conveyed as it is gripped by the grippers of the ground cylinder 18 reaches the dielectric covered electrode 16, that is, when the sheet on the ground cylinder 18 has opposed the dielectric covered electrode 16, the control device 30 turns on the corona discharge processing device 5. When the trailing edge of the sheet 3 passes the discharger 16, that is, when the outer surface of the ground cylinder 18 has opposed the dielectric covered electrode 16, the control device 30 turns off the corona discharge processing device 5.

Similarly, when the leading edge of the sheet 3 which is conveyed as it is gripped by the grippers of the ground cylinder 18 reaches the dielectric covered electrode 15, that is, when the sheet on the ground cylinder 18 has opposed the dielectric covered electrode 16, the control device 30 turns on the corona discharge processing device 5. When the trailing edge of the sheet 3 passes the discharger 15, that is, when the outer surface of the ground cylinder 18 has opposed the dielectric covered electrode 16, the control device 30 turns off the corona discharge processing device 5.

On the basis of the widthwise-direction size of the sheet 3 input from the sheet size input device 29, the control device 30 selectively turns on/off the dielectric covered electrode portions 15a to 15g and 16a to 16g which constitute the dischargers 15 and 16, respectively. More specifically, if the sheet 3 has a maximum width, the control device 30 turns on all of the dielectric covered electrode portions 15a to 15g and 16a to 16g. If the sheet 3 has a minimum width, the control device 30 turns off the dielectric covered electrode portions 15a, 15b, 15f, 15g, 16a, 16b, 16f, and 16g which are located at the first and second positions from each outer side of the ground cylinder 18 in the axial direction. Namely, only the dielectric covered electrode portions 15c, 15d, 15e, 16c, 16d, and 16e which are located close to the center are turned on.

If the sheet has a width between the maximum width and minimum width, in accordance with the size, the control device 30 turns off the dielectric covered electrode portions 15a, 15g, 16a, and 16g which are located at the first position from each outer side of the ground cylinder 18 in the axial direction, and turns on the dielectric covered electrode portions 15b, 15c, 15d, 15e, 15f, 16b, 16c, 16d, 16e, and 16f which are located closer to the center. As corona discharge is performed for only necessary portions in accordance with the sheet size, unnecessary discharge does not take place, thus saving power.

Printing operation in the sheet-fed rotary printing press having the above arrangement will be described. The sheet 3 which is fed out onto the feeder board 4 by the feed device 2 is adjusted in the widthwise direction and sheet traveling direction on the feedboard 8. Subsequently, the swing arm shaft pregripper 9 grips the leading edge of the sheet 3 and gripping-changes the sheet 3 to the grippers of the transfer cylinder 10. After being gripping-changed to the grippers of the transfer cylinder 10, the leading edge of the sheet 3 is gripping-changed to the gripper 20 of the ground cylinder 18 at a position where the transfer cylinder 10 opposes the ground cylinder 18. Then, the ground cylinder 18 conveys the sheet 3. During the conveyance by the ground cylinder 18, when the sheet 3 passes through the corona discharge processing device 5, the surface of the sheet 3 undergoes a corona discharge process by the dielectric covered electrodes 15 and 16.

The leading edge of the corona-discharge-processed sheet 3 is gripping-changed from the gripper 20 of the ground cylinder 18 to the grippers of the transfer cylinder 21 at a position where the ground cylinder 18 opposes the transfer cylinder 21. Then, the sheet 3 is conveyed. The sheet 3 conveyed by the transfer cylinder 21 is gripping-changed to the grippers of the impression cylinder 22 at a position where the transfer cylinder 21 opposes the impression cylinder 22. The sheet 3 which is conveyed after being gripping-changed to the grippers of the impression cylinder 22 undergoes printing on its corona-discharge-processed surface when it passes through a position where the impression cylinder 22 opposes the blanket cylinder 23.

In this manner, since the corona discharge process is performed immediately before printing, its effect is sufficiently maintained when the ink is to be transferred onto the sheet 3. Hence, the adhesion properties of the ink increase, the wear resistance is improved, and the destaticization properties are improved, leading to an improved quality. As the sheets 3 need not be purchased in accordance with the printing schedule, inventory management of the sheets 3 becomes possible, and a sudden printing order can sufficiently be accepted.

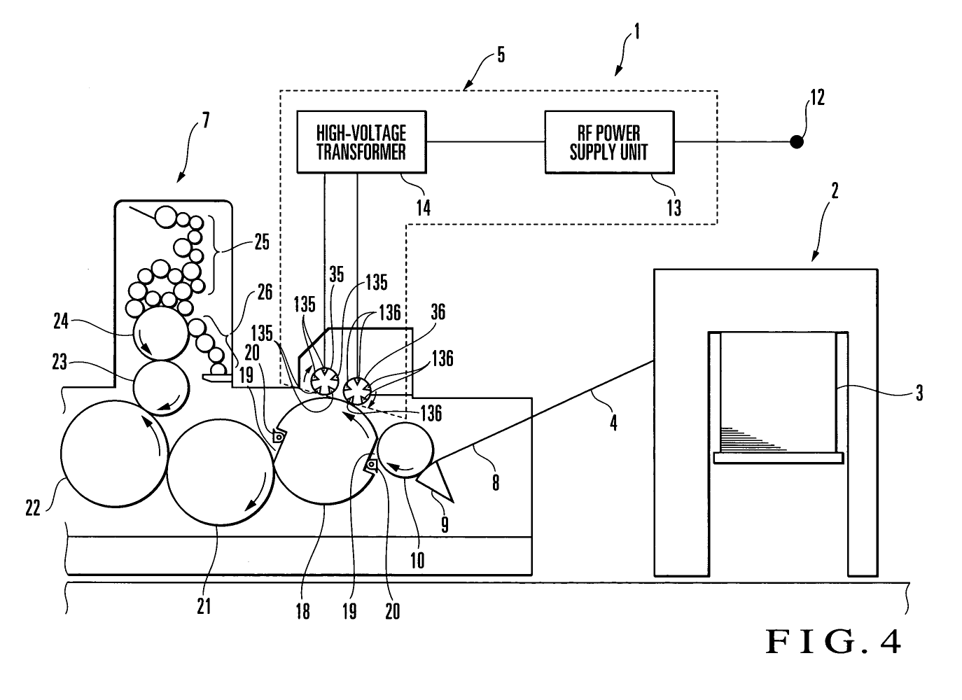

The second embodiment of the present invention will be described with reference to FIG. 4. The second embodiment is different from the first embodiment in that roll-type dielectric covered electrodes 35 and 36 replace the dischargers 15 and 16 of the first embodiment. The dielectric covered electrodes 35 and 36 are rotated in a direction opposite (clockwise in FIG. 4) to the rotation of a ground cylinder 18, i.e., in the same traveling direction as that of a sheet 3 gripped by the grippers of the ground cylinder 18, and at the same peripheral velocity as that of the ground cylinder 18. Five rows of dischargers 135 and five rows of dischargers 136 are respectively arranged in the peripheral portions of the dielectric covered electrodes 35 and 36 equidistantly in the circumferential directions.

In this arrangement, as the dielectric covered electrodes 35 and 36 rotate, the dischargers 135 and 136 of the dielectric covered electrodes 35 and 36 are sequentially turned on each time they oppose the sheet 3 held by the ground cylinder 18, and are turned off each time they cease to oppose the sheet 3 held by the ground cylinder 18. Thus, depending on the sheet traveling-direction size of the sheet 3 input from a sheet size input device 29 and the sheet position input from an encoder 28, when the sheet 3 does not oppose the dielectric covered electrodes 35 and 36, the dischargers 135 and 136 are turned off even if they oppose the outer surface o the ground cylinder 18. Depending on the widthwise-direction size of the sheet 3 input from the sheet size input device 29, the dielectric covered electrodes 35 and 36 are turned on/off in the widthwise direction in accordance with the size of the sheet 3, in the same manner as in the first embodiment.

Therefore, the surface of the sheet 3 traveling as it is gripped by the grippers of the ground cylinder 18 undergoes a corona discharge process by the dischargers 135 and 136 that are sequentially turned on. At this time, even if the sheet 3 conveyed by the ground cylinder 18 travels such that its trailing edge is levitated from the outer surface of the ground cylinder 18, no friction occurs when the trailing edge of the sheet 3 comes into contact with the dielectric covered electrodes 35 and 36. Thus, the sheet 3 will not be damaged. The dischargers 135 and 136 are sequentially turned on as they oppose the sheet 3, and are kept OFF otherwise. Therefore, when compared to the first embodiment in which the discharger 115 is kept ON while it opposes the sheet 3, the durability is improved and the number of times of maintenance operation can be reduced.

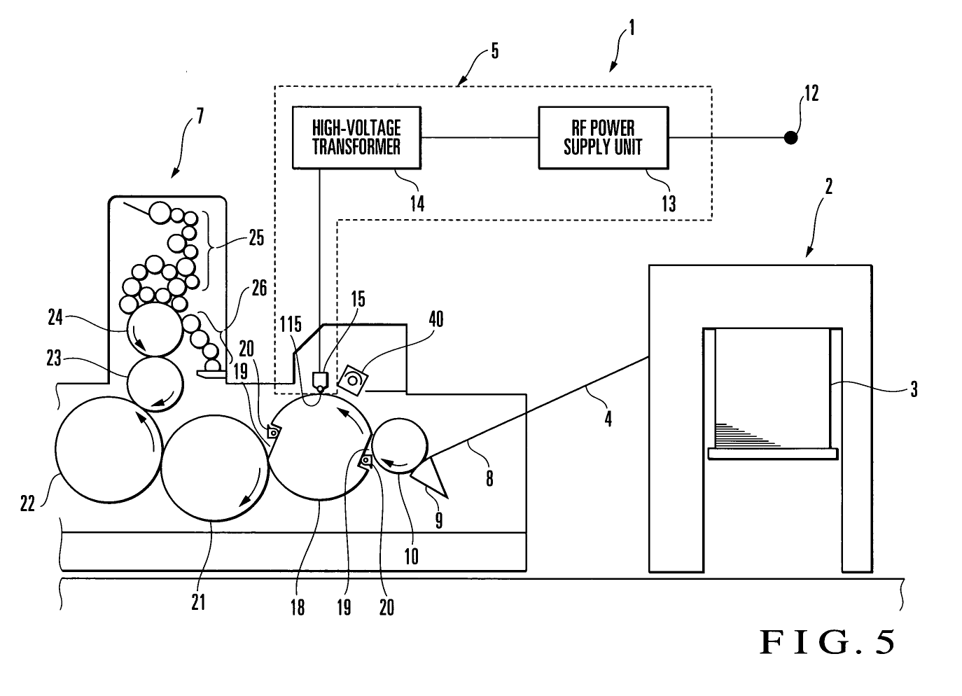

The third embodiment of the present invention will be described with reference to FIG. 5. According to the third embodiment, a heat supply (heating) device 40 which supplies heat to a sheet 3 conveyed by a ground cylinder 18 is provided upstream in the sheet convey direction to be adjacent to a dielectric covered electrode 15 having a discharger 115.

In this arrangement, heat is supplied to the sheet 3 in advance before the sheet 3 undergoes a corona discharge process by the dielectric covered electrode 15. This further improves the effect of the corona discharge process by the dielectric covered electrode 15. This is effective when the sheets 3 stacked on a feed device 2 have undergone the corona discharge process in advance and need not undergo the corona discharge process by the dielectric covered electrode 15. More specifically, the corona discharge process performed on the sheet 3 can be reactivated by only supplying heat by the heat supply device 40 to the sheet 3 which is conveyed by the ground cylinder 18.

If no heat need be supplied to the sheet 3, only the corona discharge process by the dielectric covered electrode 15 may be performed in the same manner as in the first and second embodiments. More specifically, the heat supply process by the heat supply device 40 and the corona discharge process by the dielectric covered electrode 15 may be performed selectively in accordance with the state of the sheet 3.

In the above embodiments, the first-stage dielectric covered electrode 15 or 35 and the second-stage dielectric covered electrode 16 or 36 are provided for the sake of uniforming the corona discharge process for the sheet 3. However, only the first-stage dielectric covered electrode may be necessary.

Although the liquid to transfer onto the sheet 3 is ink, it may be varnish. Although the target liquid transfer body is the sheet 3, it may be a web. In this case, as the ground cylinder 18 need not convey the web, the ground cylinder 18 does not need grippers which hold the web. As a rotary body such as the ground cylinder 18 is not necessary, only a guide device which is conductive at least partially need be provided for guiding the web. The target liquid transfer body is not limited to a printing film made of a resin, but may be paper sheet, a foil sheet, or the like.

What is claimed is:

1. A liquid transfer apparatus comprising:
a first cylinder supported rotatably;
a second cylinder arranged to oppose said first cylinder and supported rotatably;
a target liquid transfer body to which a liquid is transferred when said target liquid transfer
body travels between said first cylinder and said second cylinder;
a guide device which is conductive at least partially and arranged more upstream of said target transfer body in a traveling direction thereof than said first cylinder and said second cylinder and which guides said target liquid transfer body; and
a corona discharge processing device which is arranged to oppose said guide device and performs corona discharge for said target liquid transfer body traveling by being guided by said guide device.

2. An apparatus according to claim 1,
wherein said target liquid transfer body comprises a sheet, and
said guide device comprises a third cylinder including a holding member for holding the sheet and supported rotatably.

3. An apparatus according to claim 1,
wherein said corona discharge processing device includes a plurality of dielectric covered electrodes in a direction perpendicular to the traveling direction of said target liquid transfer body,
said plurality of dielectric covered electrodes being selectively turned on/off in accordance with a size of said target liquid transfer body in a direction perpendicular to the traveling direction thereof.

4. An apparatus according to claim 3, further comprising
size input means for inputting the size of said target liquid transfer body in the direction perpendicular to the traveling direction thereof, and
control means for selectively turning on/off said plurality of dielectric covered electrodes in accordance with the size of said target liquid transfer body output from said size input means.

5. An apparatus according to claim 1,
wherein said corona discharge processing device includes a plurality of dielectric covered electrodes arranged relative to said target liquid transfer body in the traveling direction of said target liquid transfer body,
said plurality of dielectric covered electrodes being selectively turned on/off in accordance with a size of said target liquid transfer body in the traveling direction thereof and a position of said target liquid transfer body in the traveling direction thereof.

6. An apparatus according to claim 5, further comprising
size input means for inputting the size of said target liquid transfer body in the traveling direction thereof,
position detection means for detecting the position of said target liquid transfer body in the traveling direction thereof, and
control means for selectively turning on/off said plurality of dielectric covered electrodes in accordance with the size of said target liquid transfer body in the traveling direction thereof output from said size input means and the position of said target liquid transfer body output from said position detection means.

7. An apparatus according to claim 1, wherein said corona discharge processing device includes a plurality of dielectric covered electrodes arranged in the traveling direction of said target liquid transfer body.

8. An apparatus according to claim 1, wherein said corona discharge processing device includes a plurality of dielectric covered electrodes arranged in a peripheral portion of a rotatably supported rotary body at a predetermined interval in a rotational direction of said rotary body.

9. An apparatus according to claim 1, further comprising
a heating device arranged to oppose said guide device to heat said target liquid transfer body guided by said guide device,
wherein at least one of said heating device and said corona discharge processing device is actuated in accordance with a state of said target liquid transfer body.

10. An apparatus according to claim 1, wherein said guide device includes a conductive member toward which said corona discharge processing device discharges through said target liquid transfer body.
